(19) United States
(12) Patent Application Publication
(10) Pub. No.: US 2010/0194524 A1
(43) Pub. Date: Aug. 5, 2010

(54) Home Network Control Node for Device Control and Energy Conservation

(76) Inventor: Richard John Campero, San Clemente, CA (US)

Correspondence Address: Richard John Campero, 26 Via Fontibre, San Clemente, CA, 92673, US

(21) Appl. No.: 12/363,789

(22) Filed: Feb. 2, 2009

(51) Int. Cl. G05B 23/02

(52) U.S. Cl. 340/3.1

(57) ABSTRACT

It may be desirable to reduce the energy consumption of a home or commercial building to control energy costs or to ensure that the energy consumption does not exceed what is available in non-conventional energy systems such as solar power systems. The present invention relates to a system of network control nodes that can be used to monitor and control devices such as appliances and lights to ensure that the power consumption of the entire network is within the established target levels.

### BACKGROUND

With the high energy costs of today and projected for the future, energy conservation and alternative energy solutions are becoming increasingly popular in residential and commercial facilities. When using an alternative energy solution such as solar power, wind power, or hydro-electric power the power needs of the facility are typically augmented by the conventional power grid at times of peak load or at times when the alternative energy system can not generate enough energy to supply the demands of the facilities usage. This supplemental power from the conventional power grid is not desirable since it is at a significantly higher costs basis and may not be available if the facility is a total stand alone system that is not on the conventional power grid (i.e. an off-the-grid system). In addition, even when using conventional energy sources, the facility may want to limit the amount of power consumed to control the energy costs. They may also want to operate appliances and devices during time periods when the energy usage fees are at a lower cost. This requires a system that can control and monitor the attributes of devices under control based on the total system power usage.

Energy conservation by turning off unused lights and appliances can have a significant impact on the amount of energy consumed and thereby significantly reduce the associated energy costs. In addition, scheduling of when certain appliances are operated can significantly reduce the energy costs by running these systems when the energy rates are lower or when excess alternative energy solutions are available. For example, in a home residential situation using solar power, the home owner may need to run the dishwasher and the dryer at about the same time. If both appliances are turned on at the same time, then the available power from the solar system may not be able to meet the demand of both appliances. If the start time of these two appliances were staggered then both could be operated without exceeding the capacity of the solar system. In the case of a conventional energy system, starting the appliances at night may allow for lower energy bills since this is a time of non peak power usage and the energy fees at this time may be lower than at peak times.

Numerous prior art home control systems such as Insteon™, Zwave®, etc. are currently available for control of appliances and lights but none of these home network control nodes, for example the Insteon™, allow for energy conservation through automatic control of the devices being controlled. These prior art systems are described in U.S. Pat. Nos. 7,345,998, 5,838,226, 5,848,054, 5,905,442, and 6,687,487. These systems allow lights and appliances to be controlled from a centralized controller or locally by linking of one or more of the home network control nodes. The centralized controller allows rules to be set-up for the various home network control nodes in the network and these rules are executed by the centralized controller based on the programmed events. The home network control nodes essentially act like a smart switch and turn the devices on or off and some allow the device to be dimmed. The home network control nodes only have limited control functionality and do not typically have a rules engine that can be used to control the device based on event triggers. For example, in an irrigation system the centralized controller will issue a command to the home network control node requesting that irrigation zone 1 is turned on. At a later time, the centralized controller will issue a command to the home network control node to turn zone 1 off. These devices do not allow a set of instructions to be downloaded to the home network control node to be executed locally based on event triggers. This has the following disadvantages: the centralized controller needs to be running, if communications do not make it to the home network control node then a device may be left in the on state, and failure of the centralized controller will result in the entire system being disabled. For the device of the present invention, a home network control node with the ability to download instructions may have the following command set downloaded: if rain sensor 10 is off then at 10:00 a.m. turn on zone 1 and at 11:00 a.m. turn zone 1 off. This allows the irrigation controller to monitor rain sensor 10 and also determine when to turn on and off the zone 1 devices which ensures they can not be left in the on state due to interference or failure of the centralized controller. The rain sensor and irrigation controller communicate with each other over the common communication buss. The instructions could also be issued by the centralized controller and downloaded locally to the network control node such as turn on irrigation zone 1 and leave on for 1 hour. In this situation, the centralized controller is in control of the start time and the local home network control node is responsible for turning the zone off, again without the need for the centralized controller to intervene.

The previous art control nodes also do not monitor the energy usage of the devices being controlled or any other attributes of the devices under control such as current draw, applied voltage, or the amount of time that the device may be in the on state and the prior art systems do not use this information to control the devices in the home network. This information is required to properly allocate the energy available to all of the controlled devices in the home network. For example, if the total home current load is close to exceeding the available current supply or the desired target consumption of the facility then the system of the present invention may automatically dim some of the lights that are currently on maximum to 75% of the maximum to free up additional power for other systems. Or the system could delay the start of some devices to a later time period when the current load of the system is lower.

### SUMMARY

It may be desirable to reduce the energy consumption of a home or commercial building to control energy costs or to ensure that the energy consumption does not exceed what is available in non-conventional energy systems such as solar power systems. The present invention relates to a system of network control nodes that can be used to monitor and control devices such as appliances and lights. Through monitoring of the system and control of the devices, the system can control individual network nodes to ensure that the power consumption of the entire network is within the established target levels by controlling the state of each device and scheduling of when each controlled device can be turned on and off.

### FIELD OF THE INVENTION

The present invention relates to a home, industrial, or commercial network control system that can be used to monitor and control the energy consumption of the devices under control of the network. The home network control nodes of the present invention may be built into home or commercial appliances and devices or they may be used in a standalone configuration to control the devices.

### BRIEF DESCRIPTION OF THE DRAWINGS

FIG. 1. illustrates the functional block areas of the current invention.

FIG. 2. illustrates the processing logic followed by the home network controller in the control of an appliance.

### DETAILED DESCRIPTION

Preferred embodiments and applications of the current invention will now be described. Other embodiments may be realized and changes may be made to the disclosed embodiments without departing from the spirit or scope of the invention. Although the preferred embodiments disclosed herein have been particularly described as applied to the field of home network control systems, it should be readily apparent that the invention may be embodied in any technology having the same or similar problems.

In the following description, a reference is made to the accompanying drawings which form a part hereof and which illustrate several embodiments. It is understood that other embodiments may be utilized and structural and operational changes may be made without departing from the scope of the descriptions provided.

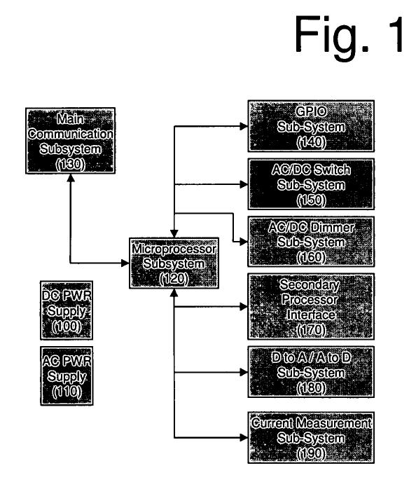

FIG. 1. illustrates the details of the subsystems that make up the present home network control node invention. The network control module has several functional block areas that contain the central processor responsible for all control and processing functions (120), a DC power subsystem (100) that supplies DC power to all components within the network control module, an AC power subsystem (110) that supplies AC to the all components within the network control module, a secondary processor bus (170) for communications with a secondary processing unit, a main communication bus (130) that allows for communication to other network control nodes and to centralized controllers, a GPIO subsystem (140), an AC/DC switch subsystem (150), an AC/DC dimmer subsystem (160), an Analog to Digital and Digital to Analog subsystem (180), and a current sensing subsystem (190).

The DC power supply subsystem (100) supplies DC power to all of the network control node components that need DC power. The AC power supply subsystem (110) supplies AC power to all of the network control node components that require AC power.

The microprocessor subsystem (120) is the central brain of the network control node and contains the microprocessor, memory, FLASH and associated components.

The main communications bus (130) is utilized by the network control node to communicate with other network control nodes and to also allow communication with the centralized controllers that may be employed within the network. These centralized controllers can be network control node devices that have been designated as centralized controllers or they could be separate controllers such as computers or embedded control systems. This communications bus may be a variety of commonly available network communications busses such as IEEE 802.15.4, IEEE 802.11, communication over ISM bands, USB, RS-485, RS-232, CAN, and other commonly used architectures. A conventional PC may also communicate with and control the home network control node using this communications bus. Over the common communication bus, the network control modules are able to exchange information with each other and all modules can behave as a distributed collection of nodes acting as a collective.

The secondary controller bus (170), allows the network control node to communicate with home, industrial, and commercial appliances and devices such as dishwashers, washing machines, dryers, coffee pots, etc. This secondary controller bus can be any one of the commonly used controller bus architectures such as I2C, SPI, 1-Wire, RS-232, RS-485, memory mapped input/output, and CAN. In one embodiment of the current invention, the network control node is built into a conventional appliance and is able to communicate with the processor system in the appliance thus allowing the node and appliance controller to act a single integrated controller. This allows the device's processor to communicate system operating parameters to the home network control node processor. This allows the network control module to determine that the user has pushed the start button and also allows the network control module to determine the settings of the appliance such as type of cycle so that the network control module can determine the run time and calculate the power that the appliance will consume during its operation. Through interface with the appliances processor unit, the network control node can also tell the appliance to start its cycle once the network control node has determined what time it should start the cycle. In another embodiment, the network control module may not be able to interface with the appliance controller and in these cases it could use the GPIO capability to determine that the appliances start button was pressed and to tell the appliance to start its cycle. In another embodiment, the network control module may replace the appliances processor unit.

The GPIO subsystem (140) allows the network control node to interface with external devices through conventional general purposes input/output control logic. These ports can be used to control things such as external relay units that may be contained within an irrigation system. It can also be used to monitor the status of devices connected to the input lines. The GPIO subsystem also contains PWM (pulse width modulated) capability.

The AC/DC switch subsystem (150), allows the network control node to act as switch allowing control of the AC power or DC power to external components. This allows the controller to turn the attached device on and off by turning the controlled devices power supply on or off. This for example, could allow the network control node to turn off a motor when instructed to do so by the centralized control system or in response to an event condition. The current measurement subsystem (190), allows the network control node to measure the current draw of the connected AC or DC device. In one embodiment, the network control node may be measuring the current supplied to a system (i.e. the power consumption) of 6 100-Watt flood lights. By measuring the power consumption of the light system, the network control node could determine that a bulb was burned out since the light system would be using less than the expected current consumption. Monitoring the current consumption of all controlled devices in the home network system also allows the system to regulate the total power consumption of the home network system.

The digital to analog and analog to digital converter subsystem (180), allows the network control node to monitor the status of attached devices and sensors. This functionality can be used to measure sensors such as temperature, light, pressure, and any other sensor that provides an analog input signal. The network control device can also control external devices that require an analog signal to operate.

The AC/DC dimmer subsystem (160), allows the network control node to control the current applied to a device. This would allow the network control node to dim attached lights to a level as specified by an event, a user, an instruction set that is stored locally, or control of a centralized controller.

It may be desirable to reduce the energy consumption of a home or commercial building to control energy costs or to ensure that the energy consumption does not exceed what is available in non-conventional energy systems such as solar power systems. The present invention relates to a system of network control nodes that can be used to monitor and control devices such as appliances and lights. Through monitoring of the system and control of the devices, the system can control individual network nodes to ensure that the power consumption of the entire network is within the established target levels by controlling the state of each device and scheduling of when each controlled device can be turned on and off. This is achieved by monitoring attributes of each network control node, monitoring attributes of each controlled device in the network, and through the use of advanced algorithms to determine what the attributes for each device and network node should be configured to.

One particular embodiment of the present invention is in the case where the network control nodes are controlling home appliances such as a dishwasher, a washing machine, and a dryer. In this example, the system may be used in a solar powered home and the system is configured to minimize the net current load to ensure that the needed home power does not exceed the available power of the solar system. In this example, we will assume that the appliances have the following specifications: the dish washer operating in the normal mode operates for 30 minutes and has a load of 5 Ah; the washing machine operating in the normal mode operates for 60 minutes and has a load of 10 Ah; the dryer operating in the normal mode operates for 60 minutes and has a load of 30 Ah. For purposes of this example, we will assume that the current supply of the solar system for the home during the time period the devices are being operated is a maximum of 35 Ah and that the general lighting on within the home is 4 Ah. The user set-ups the dishwasher and pushes the start button on the dishwasher at time 0 (t=0) thus telling the dishwasher and the network control node for the dishwasher that they want the dishwasher to run. The network control node knows that it can start the dishwasher immediately since the total load on the system is 9 Ah. At a few minutes later in time, at t=5 minutes, the user loads the dryer and hits the start button telling the dryer and network control node for the dryer that they want to start the dryer. The network control node will not allow the dryer to start at this time since the total load on the system with the dryer in the on position will be 39 Ah which exceeds the capacity of the system. A short time later, at t=20 minutes, the user loads the washer and hits the start button signifying to the washer and the associated network control module that they want to run the washer. The network control node will immediately start the washer since the load on the system will be 19 Ah which is less than the systems maximum capacity. Once the washer and the dishwasher complete their cycles the network control node controlling the dryer will then start the dryer if the load of the system can support its operation which it should in the example given.

In the example above, a simple algorithm to determine when to start the appliances was employed. Essentially the start condition was simply start the appliances immediately if the power consumption limit would not be exceeded and then additional units that were put into the start state would begin to operate if the system could accommodate their load. In a real application it would likely be that the system would use a more advanced algorithm to determine when appliances could be started and may employ priority based queues to ensure all appliances have the ability to operate within a reasonable start time period.

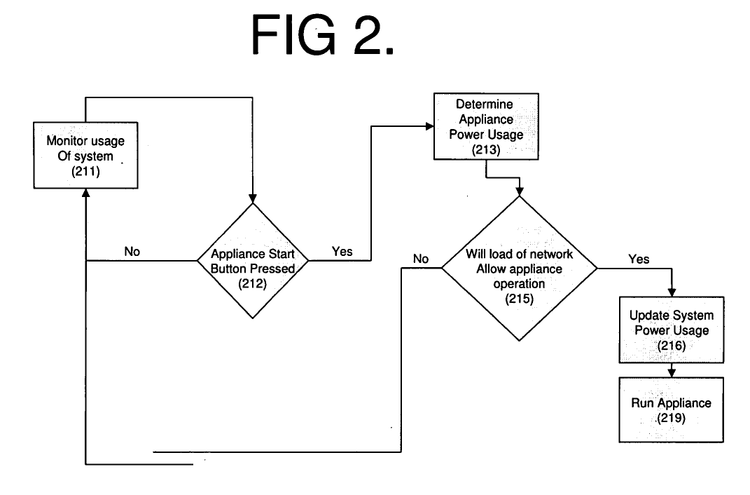

The simplest algorithm that the system could employ could be a standard round robin scheduling queue where the start time of the appliances and devices is in order without any priority levels. This simplistic algorithm, illustrated in FIG. 2., would not optimize the number of appliances that could be operated concurrently since they are started in series without consideration of the current draw of the appliances and capacity of the system and also without the ability to have certain appliances and devices have a higher priority level. More advanced queue processing algorithms can be employed that are based on the anticipated time that the device or appliance are going to run for, the assigned priority level of the appliance versus others that are in the queue to be operated, as well as algorithms based on other attributes such as current load of the device or appliance or the power consumption of the device or appliance for the duration of the cycle.

FIG. 2. illustrates one of the more simple algorithmic process that allows the network of home network control nodes to determine when the appliances should be started. The algorithm is shown as main processing units as numbered in FIG. 2. The first processing function is that the network control node (211) listens to the other network control nodes in the system and stores the current power consumption value of the system. It is also monitoring for the appliance start command (212) that could be receive from one of the GPIO inputs or from the appliance controller. If the appliance is to be started then a processing block (213) determines the power usage of the appliance from the appliance controller or from a stored value of the devices power consumption that was configured at system start-up or from a measured value of the appliance operation. This power consumption value can be also be determined over time through measurement of the actual power consumption of the device during operation. If the power consumption of network will allow operation of the appliance (215) then the network control node will update the network with the new power consumption level (216) and the appliance will be started (219). If the power consumption of the network will not allow operation of the device the network control node will monitor the usage of the network (211) until it is able to run and it will start the appliance (219). Once the appliance is stopped the network control node goes back to the beginning of the cycle (212) and the home network node collective is alerted to the decreased system load. FIG. 2. illustrates the simple algorithm and it could be expanded to encompass the more advanced algorithms described in this specification as would be apparent to someone skilled in the art. In addition, the system load can be dynamically determined since the actual power consumption of the devices in the network are being measured by their respective control node.

The home network control nodes can utilize various control schemes to manage the queue processing. In one configuration, the queue scheduling could be maintained and controlled by a centralized controller or centralized PC. In another configuration, the queue management could be administered by the home network control node collective since they are in constant communication with each other over the main communications sub-system, have local memory storage, local processing power, and have local rules engine processing capability. In this configuration, the network or home network control nodes acts as a distributed cluster of processing units that work collectively to manage the start times and operation of the attached devices and appliances. An example of this architecture approach is the cooperative job scheduling algorithm described in the Job Scheduling Scalability white paper by ORSYP. In addition, the home network control node could be programmed to override the usage limits if instructed to do so by the user of the system. For example, the home network control node could have an override button that when pushed would start the appliance regardless of the current power usage of the system. Other algorithms could be utilized as known to those skilled in the art.

In addition, the algorithms controlling the start of the appliances can accommodate the user starting and stopping the appliance without the appliance losing its position in the queue. For example, a user may load and start the washing machine and based on the queue the appliance starts immediately. The user then may decide to add additional items to the washing cycle and they stop the washer. It would be undesirable for the washer to loose its cycle in the queue since this is a momentary interruption in the appliance cycle. In this case, the algorithm could wait for a period of time to allow the user to add the items to the system and if they do not within a period of time the appliance would tell the network that it was completed and it would be released from the queue. Once the user adds the additional items to the washer and pushes start, then the washer would rejoin the queue.

The network control nodes of the present invention allow for the downloading of instructions to the local memory for local execution based on events within the system. The rules can be downloaded to the devices from a personal computer on the main communication subsystem (130) or connected to the device through another protocol or it may be downloaded to the network control node from a centralized controller system. The rules contain the following basic elements: an event condition that specifies the event condition that will trigger the invocation of the rule; a condition part that is a logical test condition that when satisfied will trigger the invocation of the rule action; and a rule action part that performs a specified action. An example rule that may be downloaded may be the following: the event condition is to start the rules processing when the appliance start button is pressed; the condition part of the rule is that the appliance will be started if the available power capacity of the system can accommodate the load of the appliance; and the rule action part would be to update the system load and start the appliance. In this example, the maximum available power of the system would be set by the user during system set-up or determined directly through interface with the solar power controller.

As another example, a basic command that can be downloaded to the network control node could also be to turn on a set of lights that are connected to the network control module at a dimming level of 75%, monitor the power consumption of the lights, and update the system usage based on the power consumption of the lights.

The examples above describe the embodiment where the home network control node is utilized in a system to control the total energy consumption in a solar powered or alternative energy situation. In a related embodiment, the control algorithms could be configured to optimize the start times of the devices and appliances to achieve the lowest energy costs by delaying the start times of the devices to a time period where the energy usage fees are a minimum. The algorithm could also control the start time of the appliances to ensure that the daily, weekly, or monthly energy usage goals can be achieved. During system configuration the system would be programmed with the energy cost tables that indicate what the cost for energy are during the different time periods throughout the day. The network control node would also be programmed with the facility energy usage targets

In another embodiment, the home network control node could be packaged as a separate device from home appliances and used to control lamps and other AC powered devices. In this configuration, the AC/DC switch subsystem (150) would control an AC plug that the device under control could be plugged into. In addition, the network control node could dim the device and determine the actual power consumption of the device. It could also alert the user if the device is not operating properly as determined from the energy consumption of the device.

In addition to use in AC systems, the home network control node could be used in systems that are powered from DC. For example, a home network control node could be built into outdoor DC powered landscape lighting systems. In this scenario, the system would allow individual on/off and dimming control of each light in the system. The system could also alter the user if the light bulb in the light under control is burned out. This would be determined by measuring the energy consumption of the lamp module.

### REFERENCES CITED U.S. PATENT DOCUMENTS

| | | |
|---|---|---|
| 7,345,998 | Dec. 15, 2004 | Cregg et al. |
| 5,838,226 | Feb. 7, 1996 | Houggy et al. |
| 5,848,054 | Feb. 7, 1996 | Mosebrook et al. |
| 5,905,442 | Feb. 7, 1996 | Mosebrook et al. |
| 6,687,487 | Jul. 26, 1999 | Mosebrook et al. |

### OTHER REFERENCES

“Job Scheduling Scalability.” ORSYP. 2009. <http://www.orsyp.com/us/resources/white-papers/134.html?DOC TYPE=WP&DOC ID=24&title=Job+Scheduling+Scalability ≦.

What is claimed as new and desired to be protected by Letters Patent of the United States is:

1. A home network control node device that controls the power applied to an attached device under control and that communicates with a system of home network control nodes over a main communications bus and can download instructions to local memory for local execution based on events that occur in the system of home network control nodes where the downloaded instructions comprise:
an event condition that specifies the event condition that will trigger the invocation of the rule;
a condition part that is a logical test condition that when satisfied will trigger the invocation of the rule action;
and a rule action part that performs a specified action.

2. The home network control node device of claim 1, wherein the home network control node device is utilized in a system to control the total energy consumption in a solar powered or alternative energy system.

3. The home network control node device of claim 1, wherein the home network control node device measures the energy usage of the attached device under control.

4. The home network control node device of claim 1, where the turning on of the attached device under control is based on the power consumption of the attached device under control.

5. The home network control node device of claim 1, where the turning on of the attached device under control is based on the priority of the attached device under control.

6. The home network control node device of claim 1, where the turning on of the attached device under control is based on the available energy of the network.

7. A home network control node device that communicates with a system of home network control nodes over a main communications bus and where the home network control node device controls the operation of an attached device under control based on the energy consumption of the network of attached devices under control.

8. The home network control node device of claim 7, wherein the home network control node device is utilized in a system to control the total energy consumption in a solar powered or alternative energy system.

9. The home network control node device of claim 7, wherein the home network control node device measures the energy usage of the attached device under control.

10. The home network control node device of claim 7, where the turning on of the attached device under control is based on the power consumption of the attached device under control.

11. The home network control node device of claim 7, where the turning on of the attached device under control is based on the priority of the attached device under control.

12. The home network control node device of claim 7, where the turning on of the attached device under control is based on the available energy of the network.

13. A method of using a system of home network control devices that communicate over a main communications bus to monitor and control attached devices under control to ensure that the power consumption of the entire network of devices under control is within the established target levels or within the power available to the network comprising the steps of:
determining the current power consumption of all attached devices under control in the network;
determining, when a device under control is to be turned on, the power consumption of the device under control from a stored value of the device under controls power consumption or from a current or previous actual measurement of the device under control power consumption;
determining, based on the current power consumption of the network of devices under control and the power consumption of the device under control that is to be turned on, whether the network can accommodate the additional power consumption of the device under control that is to be turned on;
wherein, if the network can accommodate the additional power consumption of the device under control that is to be turned on then the network control node device will update the network with the power consumption level of the device under control that is to be turned on and will then turn on the device under control that is to be turned on;
wherein, if the network can not accommodate the additional power consumption of the device under control that is to be turned on then the network control node device will monitor the power consumption of the network of devices under control and will turn on the device under control when the network can accommodate the additional power consumption of the device under control that is to be turned on.

14. The method of claim 11, wherein the home network control node device is utilized in a system to control the total energy consumption of all devices under control in the home network in a solar powered or alternative energy system.

15. The method of claim 11, wherein, if the network can not accommodate the additional power consumption of the device under control that is to be turned on then the network control node device will be placed into a queue for scheduling.

16. The method of claim 15, where the queue scheduling is maintained and controlled by a centralized controller.

17. The method of claim 15, were the queue scheduling is administered by the home network control node collective where the home network control node devices act as a distributed cluster of processing units that work collectively to manage the start times and operation of the devices under control.

18. The method of claim 15, where the queue scheduling is a round robin scheduling queue

19. The method of claim 15, where the queue scheduling is based on one or more attributes of the device under control.

20. The method of claim 19, where the attributes of the device under control include one or more the following: anticipated time that the device under control will be on for; the assigned priority of the device under control; power consumption of the device under control.
